(19) United States
(12) Patent Application Publication
(10) Pub. No.: US 2025/0372997 A1
(43) Pub. Date: Dec. 4, 2025

(54) METHODS AND APPARATUS FOR ARC DETECTION

(71) Applicant: Texas Instruments Incorporated, Dallas, TX (US)

(72) Inventors: Nathan Nohr, Dallas, TX (US); Henrik Mannesson, Allen, TX (US)

(21) Appl. No.: 19/096,306

(22) Filed: Mar. 31, 2025

Related U.S. Application Data
(60) Provisional application No. 63/652,408, filed on May 28, 2024.

(51) Int. Cl. H02H 1/00; G06N 3/08; H02H 3/16

(52) U.S. Cl. CPC H02H 1/0015; G06N 3/08; H02H 1/0092; H02H 3/162

(57) ABSTRACT

An example apparatus includes: current measurement circuitry having an output, log amplifier circuitry having an input coupled to the output of current measurement circuitry and having an output, analog to digital conversion (ADC) circuitry having an input coupled to the output of the log amplifier circuitry and an output, and programmable circuitry having an input coupled to the output of the ADC circuitry and having an output, wherein the programmable circuitry is configured to detect an arc within an Alternating Current (AC) signal provided to the current measurement circuitry.

### CROSS REFERENCE TO RELATED APPLICATION

This patent application claims the benefit of and priority to U.S. Provisional Patent Application Ser. No. 63/652,408 filed May 28, 2024, which Application is hereby incorporated herein by reference in its entirety.

### TECHNICAL FIELD

This description relates generally to electrical arcing and, more particularly, to methods and apparatus for arc detection.

### BACKGROUND

Arc faults are a luminous discharge of electricity across an insulating medium. These faults may occur for reasons including but not limited to poor insulation material, missing insulation, broken wires, etc. Sustained arcing can, in some instances, cause fires and other dangerous conditions. If the arc can be detected and the circuit cut off before the arc occurs, damage to components and other dangerous conditions can be avoided.

### SUMMARY

For methods and apparatus for arc detection, a first example apparatus includes: current measurement circuitry having an output, log amplifier circuitry having an input coupled to the output of current measurement circuitry and having an output, analog to digital conversion (ADC) circuitry having an input coupled to the output of the log amplifier circuitry and an output, and programmable circuitry having an input coupled to the output of the ADC circuitry and having an output, wherein the programmable circuitry is configured to detect an arc within an Alternating Current (AC) signal provided to the current measurement circuitry.

A second example apparatus includes: current measurement circuitry having an output, log amplifier circuitry having an input coupled to the output of current measurement circuitry, and control circuitry having an input coupled to the log amplifier circuitry and having an output coupled to a circuit breaker, wherein the control circuitry is configured to detect an arc within an alternating current (AC) signal provided to the current measurement circuitry, and trip the circuit breaker in response to the detection.

An example non-transitory machine readable storage medium includes instructions that, when executed, cause at least one processor to detect an arc by executing a machine learning model, wherein an input to the machine learning model are digital samples that correspond to a logarithmically scaled representation of energy within a frequency band of an Alternating Current (AC) signal.

### BRIEF DESCRIPTION OF THE DRAWINGS

FIG. 1 is a block diagram of an example environment that delivers power to a load.

FIG. 2 is a graph of the example characteristics of a current signal generated by the Alternating Current (AC) power supply circuitry of FIG. 1.

FIG. 3 is a block diagram of an example implementation of the arc detector circuitry of FIG. 1.

FIG. 4 is a block diagram of an example implementation of the log amplifier circuitry of FIG. 3.

FIG. 5 is a graph of an example performance of the log amplifier circuitry of FIG. 3.

FIG. 6 is an illustrative example of operations performed by the neural network processor unit (NNPU) of FIG. 3.

FIG. 7 is a flowchart representative of example operations that may be executed, instantiated, or performed by the arc detector circuitry of FIG. 3 to detect arcs.

FIG. 8 is a flowchart representative of example operations that may be executed, instantiated, or performed by the digital domain circuitry of FIG. 3 to detect arcs.

FIG. 9 is a block diagram of an example processing platform including programmable circuitry structured to execute, instantiate, or perform the example machine readable instructions or perform the example operations of FIGS. 7 and 8 to implement the arc detector circuitry 106 of FIG. 3.

The same reference numbers or other reference designators are used in the drawings to designate the same or similar (functionally or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines or boundaries may be idealized. In reality, the boundaries or lines may be unobservable, blended or irregular.

Commercial arc detectors are used in a wide variety of residential and industrial settings to prevent harm to life and property. To stay competitive in a crowded market and to reduce device and operational cost, commercial arc detectors generally have relatively few computational resources and consume a relatively low amount of power. These resources and power limitations restrict commercial arc detectors to the implementation of comparatively simple arc detection techniques based on analog processing of small frequency bands. However, such arc detection techniques are frequently unable to distinguish an actual arc from load devices, such as brushed motors and switch mode power supplies, whose regular operation resembles an arc. Thus, known commercial arc detectors may suffer from false detection rates of up to 40%. System efficiencies and user experience suffer each time an arc detector unnecessarily cuts off power from the load device.

Some arc detectors attempt to use machine learning algorithms to increase the accuracy of arc detection. While known arc detectors that use machine learning can be more accurate than other detectors that use known analog threshold based algorithms, the execution of the machine learning algorithm requires a relatively large number of computational resources and consume a relatively high amount of power. Thus, known machine learning arc detection techniques are more costly than known analog threshold-based arc detection techniques, and therefore are less competitive in the market.

Example methods, apparatus, and systems described herein implement an arc detection system that is more accurate than commercial arc detectors while still being inexpensive and competitive in the marketplace. Example arc detector circuitry described herein includes analog domain circuitry and digital domain circuitry. In the analog domain circuitry, example logarithmic (LOG) amplifier circuitry generates a logarithmically scaled signal of the AC energy within a high frequency band of a current signal. The example LOG amplifier circuitry may also provide a low frequency band of the current signal and frequency detect signal. Within the digital domain circuitry, an example artificial intelligence (AI) model uses at least a digitized version of the logarithmically scaled signal to detect arcs in the current signal. The AI model enables the example arc detector circuitry to be more accurate than known commercial arc detectors. The signal preconditioning performed in the analog domain circuitry also enables the digital domain circuitry to perform arc detection accurately while requiring a relatively small number of computational resources and consuming a relatively low amount of power in comparison to other known arc detection techniques. Thus, the example combination of analog preprocessing and digital analysis described herein is more accurate and less expensive than known arc detection techniques.

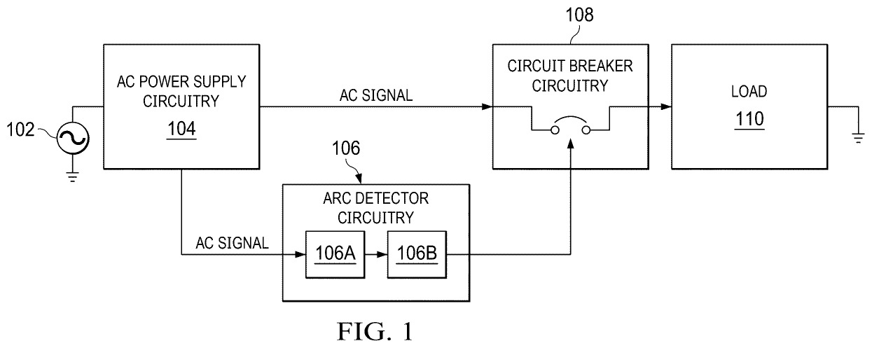

FIG. 1 is a block diagram of an example environment 100 that delivers power to a load. The environment 100 includes an example power source 102, example AC power supply circuitry 104, example arc detector circuitry 106, example circuit breaker circuitry 108, and an example load 110.

The power source 102 provides AC power to the example environment of FIG. 1. The example power source 102 may be implemented by any device providing electrical energy in AC. As described herein, the term “AC signal” refers to how the characteristics of the AC power (current, voltage, phase, shape, etc.) provided by the power source 102 change over time.

The AC power supply circuitry 104 provides the AC signal to the circuit breaker circuitry 108 and the arc detector circuitry 106. The AC signal is analyzed by the arc detector circuitry 106 and powers the load 110, as described further below. The AC power supply circuitry 104 can also power the arc detector circuitry 106. In some examples, the AC power supply circuitry 104 powers the arc detector circuitry 106 using a modified version of the AC signal.

The arc detector circuitry 106 has an input coupled to the AC power supply circuitry 104 and an output coupled to the circuit breaker circuitry 108. The arc detector circuitry 106 analyzes the signal provided by the AC power supply circuitry 104 to determine, in substantially real time, whether current in the signal is arcing. Speed is a performance requirement of the arc detector circuitry 106 because if the arc detection process operates sufficiently slow, an arc can start a fire and cause damage before the arc detector circuitry 106 identifies the arc and trips the circuit breaker circuitry 108.

As used above and herein, “substantially real time” refers to occurrence in a near instantaneous manner recognizing there may be real world delays for computing time, transmission, etc. In this example, the arc detector circuitry 106 generates a new arc detection result twice per cycle of the AC signal. Thus, unless otherwise specified, “substantially real time” refers to real time+8.33 milliseconds (ms) in the examples described below. In other examples, “substantially real time” refers to real time+a different amount of time, where the different amount of time is based on the duty cycle of the AC signal.

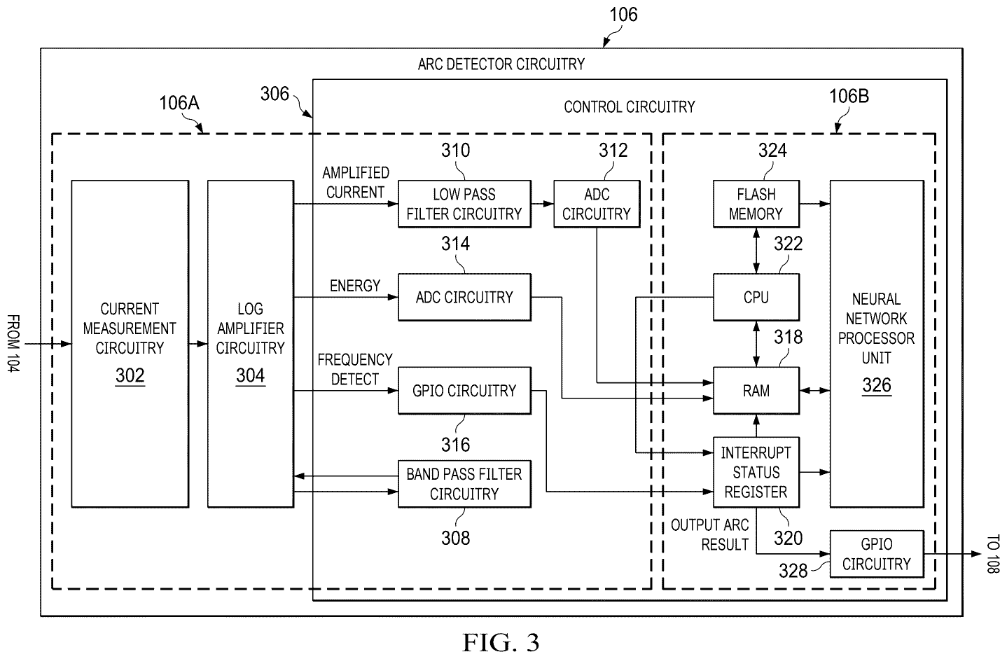

The arc detector circuitry 106 may alter one or more of the voltages, frequency, shape of signal, number of phases, etc., of the AC signal for the purpose of detection. Within the arc detector circuitry 106, the analog domain circuitry 106A has an input coupled to the AC power supply circuitry and an output coupled to the digital domain circuitry 106B. The analog domain circuitry 106A preconditions the AC signal. The digital domain circuitry 106B then uses the output of the analog domain circuitry 106A to execute a machine learning model that detects arcs. The analog domain circuitry 106A and the digital domain circuitry 106B are described further in connection with FIG. 3.

The circuit breaker circuitry 108 has a first input coupled to the arc detector circuitry, a second input coupled to the arc detector circuitry 106, and an output coupled to the load 110. The circuit breaker circuitry 108 operates in either a normal mode or a tripped mode. The circuit breaker circuitry 108 couples its first input to its output when in normal mode, thereby creating a closed circuit that provides the current signal to the load 110 at its output. The circuit breaker circuitry 108 decouples its first input from its output when in tripped mode, thereby creating an open circuit that prevents the flow of current to the load 110. In this example, the circuit breaker circuitry 108 determines which state to operate in based on the signal provided by the arc detector circuitry 106 at its second input. In some examples, the circuit breaker circuitry 108 can also trip itself if the amount of current in the signal from the AC power supply circuitry 104 exceeds a threshold amperage.

In the example of FIG. 1, the load 110 refers to any device capable of using the power from the output of the circuit breaker circuitry 108 to perform operations. In some examples, the load 110 may require specific amounts of power at specific times to perform various operations. Such requirements may generally be referred to as performance requirements of the load 110. The AC power supply circuitry 104 may change one or more characteristics of the generated AC signal to meet the power requirements of the load 110.

The operations performed by the load 110 can correspond to any application or use case. In some examples, the power requirements of the load 110 cause the AC power supply circuitry 104 to generate a current signal whose characteristics during a normal mode of operation resemble an arc. Such devices include but are not limited to brushed motors and switch mode power supplies as described above.

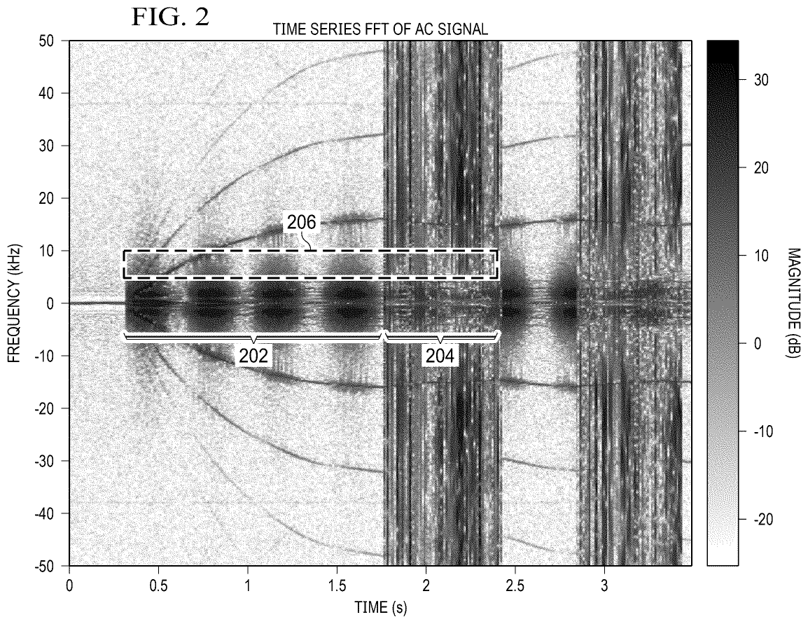

FIG. 2 is a graph of the example characteristics of a current signal generated by the arc detector circuitry 106 of FIG. 1. The graph 200 of FIG. 2 includes an example time window 202, an example time window 204, and an example frequency band 206.

The graph 200 is a time series Fast Fourier Transform (FFT) of an example AC signal generated when the load 110 is a commercial vacuum motor during both normal operations and an arc. Thus, FIG. 2 shows how both the frequency and magnitude of the current signal change over time in such an example. The graph 200 displays time on the x axis as measures in seconds and frequency on the y axis as measured in kilohertz (kHz). The graph 200 also changes shade based on the magnitude of the current signal as measured in decibels (dB), where darker shades of grey indicate a larger magnitude and lighter shades of grey indicate a smaller magnitude.

The time window 202 refers to a portion of the graph 200 that begins at approximately 0.3 seconds and ends at approximately 1.75 seconds. In the example of FIG. 2, the AC signal supports the normal operation of the load 110 (for example, the vacuum motor) without arcing during the time window 202. The time window 202 shows that the power requirements of the load 110 cause the AC signal to produce pulses of current between approximately [−5 kHz, +5 kHz]that are approximately 30 dB in magnitude. The time window 202 also shows that the creation of these current pulses causes both noise (for example, nonzero amounts of current around +10 kHz and −10 kHz) and harmonics that can extend upwards to 50 kHz.

The time window 204 refers to a portion of the graph 200 that begins at approximately 1.75 seconds and ends at approximately 2.4 seconds. In the example of FIG. 2, the AC signal arcs during the time window 204. In a time-series FFT such as the graph 200, the signature of an arc generally resembles pseudo-random noise that continuously changes magnitude between a range of frequencies (for example, −50 kHz to +50 kHz in FIG. 2). In some examples, an arc signature is referred to as 1/f noise, fractal noise, or fractional noise because the magnitude of the current decreases at higher frequencies (for example, above +50 kHz in FIG. 2).

FIG. 2 shows that arcs can be visually distinctive when viewing the entirety of the graph 200. However, measuring all or even most of the frequencies shown in FIG. 2 would require extreme amounts of data and computational resources such that known techniques that receive similar amounts of data are too expensive to compete in the marketplace. Thus, instead of measuring a large frequency range, known commercial arc detectors generally operate by analyzing select frequency bands within the AC signal. However, limiting analysis to a selected band of frequencies decreases the accuracy of arc detection for multiple reasons.

As a first example, many known commercial arc detector analyze a low frequency band (for example, the frequency band 206 in FIG. 2 shows only data between +5 kHz and +10 kHz) because the number of samples required to measure a signal increases with frequency, so analyzing a low frequency band reduces the number of samples needed and therefore reduces cost. However, at such ranges, the frequency band 206 shows that the combination of a) current pulses required by the load 110, b) noise surrounding the current pulses, and c) harmonics caused by the current pulses, form a profile that is similar to the arc. Thus, limiting analysis to low frequency bands generally decreases accuracy because it is difficult to distinguish between normal operation of a load 110 and an arc at such ranges. More generally, if the known commercial arc detector relies on a pre-selected frequency spectrum, the spectrum cannot account for every possible future load which could cause a false trip. This unpredictability of the future load exists regardless of whether the arc detection technique relies on a threshold or integral of the selected band.

As a second example, some known arc detection techniques may select frequency bands higher than 1 megahertz (MHz) such that there is a very low probability of load noise interfering with the arc signal. However, sampling such a high frequency band requires so many samples that computationally expensive compute resources (for example, high end microprocessors, math accelerators, etc.) are needed to analyze the data quickly enough for the arc detector to be effective. More generally, increasing the range of the frequency band adds cost and limits competitiveness as described above. Furthermore, at such high frequency bands, transients within the arc that do not reach the same frequency as the selected band will be excluded from the analysis.

In the examples described herein, the analog domain circuitry 106A analyzes a high frequency band (for example, from 800 kHz to 10 MHz) but samples the frequency band at a slower rate (for example, 100 kHz). Thus, the analog domain circuitry 106A remains cost competitive while also using a frequency band that reduces the probability that nonzero data is caused by the power requirements of a load. The digital domain circuitry 106B then employs a machine learning model to further analyze the analog output using comparatively limited data, thereby increasing the accuracy of the arc detection without significantly impacting cost.

FIG. 3 is a block diagram of an example implementation of the arc detector circuitry 106 of FIG. 1. The example of FIG. 3 shows that the arc detector circuitry 106 includes example current measurement circuitry 302, example log amplifier (LOG AMP) circuitry 304, and an example control circuitry 306. The control circuitry 306 includes example band pass filter (BPF) circuitry 308, example low pass filter (LPF) circuitry 310, example analog to digital conversion (ADC) circuitry 312 and 314, example General Purpose Input Output (GPIO) circuitry 316 and 328, example Random Access Memory (RAM) 318, an example Interrupt Status Register (ISR) 320, an example Central Processor Unit (CPU) 322, example flash memory 324, and an example Neural Network Processor Unit (NNPU) 326.

In the example of FIG. 3, the analog domain circuitry 106A refers to the current measurement circuitry 302, the LOG AMP circuitry 304, the BPF circuitry 308, the LPF circuitry 310, the ADC circuitry 312 and 314, and the GPIO circuitry 316. Similarly, the example of FIG. 3 shows the digital domain circuitry 106B refers to the RAM 318, the ISR 320, the CPU 322, the flash memory 324, the NNPU 326, and the GPIO circuitry 328. In other examples, one or more components shown in FIG. 3 are labelled differently.

Within the analog domain circuitry 106A, the current measurement circuitry 302 has an input coupled to the AC power supply circuitry 104 and an output. The current measurement circuitry 302 generates a voltage at its output that is proportional in magnitude to the amount of current in the AC signal. Thus, the generated voltage signal changes magnitude at the same frequency as the AC signal. The current measurement circuitry 302 may be implemented using any suitable current measurement technique. Such techniques include but are not limited to a shunt resistor, a current transformer, a Rogowski coil, etc.

In the example of FIG. 3, the LOG AMP circuitry 304 has a first input coupled to the current measurement circuitry 302, a first output coupled to the BPF circuitry 308, a second input coupled to the BPF circuitry 308, a second output coupled to the ADC circuitry 314, a third output coupled to the LPF circuitry 310, and a fourth output coupled to the GPIO circuitry 316. In other examples, the LOG AMP circuitry 304 may have a different number of inputs or outputs. In some examples, the inputs or outputs of the LOG AMP circuitry 304 are indexed differently than the example of FIG. 3.

The LOG AMP circuitry 304 provides (at its first output) an amplified version of the generated voltage signal to the BPF circuitry 308. The BPF circuitry 308 returns (at the second input of the LOG AMP circuitry 304) an edited version of the generated voltage signal that includes only the portions of the signal between a predetermined frequency range. Thus, the BPF circuitry 308 is configured to filter out any portion of the signal that has a lower frequency or a higher frequency than [[0]] the predetermined range. As used herein, the terms “predetermined frequency range” and “frequency band” may be used interchangeably. In this example, the frequency band stretches between 800 kHz and 10 MHz as described above. In other examples, the BPF circuitry 308 uses a different frequency band.

The LOG AMP circuitry 304 provides at its second output a signal that is a logarithmically scaled representation of the AC energy within the frequency band. As used herein, the signal provided at the second output of the LOG AMP circuitry 304 may be referred to as the energy signal. The energy signal is the primary signal used by the digital domain circuitry 106B to detect arcs, as described further below.

In this example, the LOG amplifier circuitry 304 also provides (at its third output) a frequency detect signal. The voltage of the frequency detect signal alternates at the same frequency as the instantaneous signal whose AC energy is being measured. Because the LOG AMP circuitry 304 only measures the energy of the frequency band, the instantaneous frequency of the frequency detect signal may vary anywhere within the frequency band. Furthermore, the upper and lower bounds of the frequency band can be determined by observing the frequency detect signal over a sufficient period of time.

In this example, the LOG AMP circuitry 304 also provides (at its fourth output) an amplified version of the signal provided by the current measurement circuitry 302. As used herein, the signal provided at the fourth output of the LOG AMP circuitry 304 may be referred to as the amplified current signal or the amplified signal. The amplified current signal enables the digital domain circuitry 106B to also consider data outside of the frequency band when detecting an arc. In other examples, the LOG AMP circuitry 304 does not provide one or both of the frequency detect signal or the amplified current signal to the digital domain circuitry 106B.

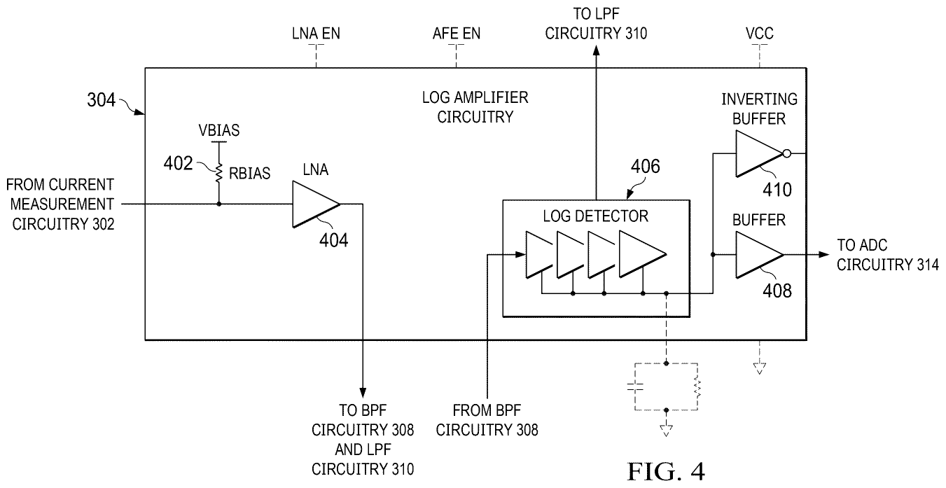

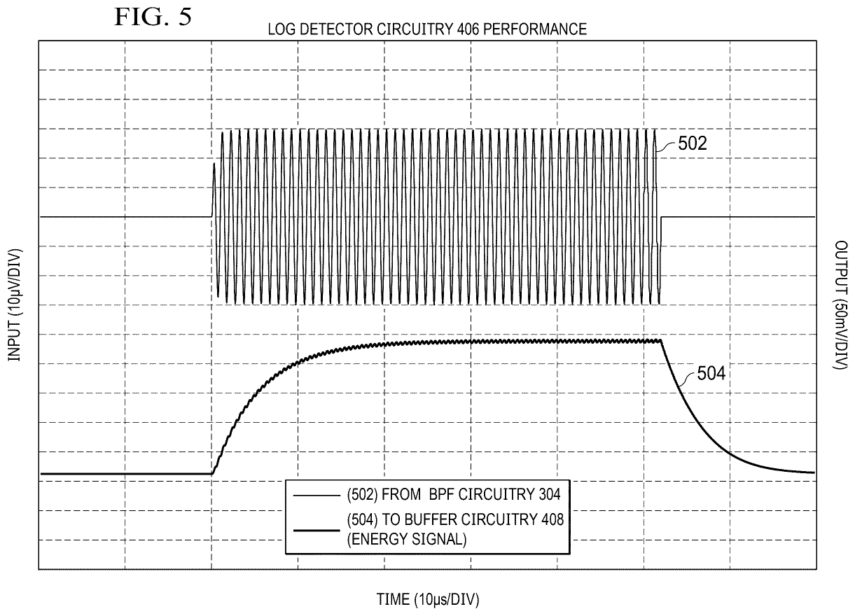

In this example, the LOG AMP circuitry 304 is implemented by the LOG 300 log detector manufactured by Texas Instruments. In other examples, the LOG AMP circuitry 304 is implemented by a different product or design. The LOG AMP circuitry 304 is described further in connection with FIGS. 4 and 5.

The control circuitry 306 analyzes the signals at the outputs of the LOG AMP circuitry 304 to detect arcs in substantially real time. In this example, the control circuitry 306 is implemented by the MSPMOG3507 microcontroller manufactured by Texas Instruments. Thus, the LPF circuitry 310 and the BPF circuitry 308 are implemented within the control circuitry 306 in the example of FIG. 3 because the filters are on the MSPMOG3507 circuit board. More generally, the control circuitry 306 may be implemented by any type of programmable circuitry that includes a NNPU. Thus, in other examples, one or both of the LPF circuitry 310 and the BPF circuitry 308 may be designed and manufactured independently from the circuit board that implements the NNPU 326.

The control circuitry 306 of FIG. 3 may be instantiated (for example, creating an instance of, bring into being for any length of time, materialize, implement, etc.) by programmable circuitry such as a Central Processor Unit (CPU) executing first instructions. Also or alternatively, the control circuitry 306 of FIG. 3 may be instantiated (for example, creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 3 may, thus, be instantiated at the same or different times. Some or all of the circuitry of FIG. 3 may be instantiated, for example, in one or more threads executing concurrently on hardware or in series on hardware. Moreover, in some examples, some or all of the circuitry of FIG. 3 may be implemented by microprocessor circuitry executing instructions or FPGA circuitry performing operations to implement one or more virtual machines or containers.

The LPF circuitry 310 has an input coupled to the fourth output of the LOG AMP circuitry 304 and an output coupled to the ADC circuitry 312. The LPF circuitry 310 provides at its output an edited version of the amplified voltage signal that only includes portions below a threshold frequency. In this example, the threshold frequency of the LPF circuitry 310 is 100 kHz. The threshold frequency is determined by the maximum number of samples that can be processed in substantially real-time (8.3 ms in this example). In other examples, the LPF circuitry 310 uses a different threshold frequency.

The ADC circuitry 312 has an input coupled to the output of the LPF circuitry 310 and an output coupled to the RAM 318. The ADC circuitry 312 samples the analog voltage of the low frequency signal provided at its input. The ADC circuitry 312 then provides at its output digital values that represents the sampled voltages. Notably, the ADC circuitry 312 can sample the low frequency signal while preserving signal integrity at a lower sample rate than would be necessary if the LPF circuitry were not implemented upstream (for example, if the LOG AMP circuitry 304 provided the amplified voltage signal at its full range of frequencies directly to the ADC circuitry 312). The reduced sample rate in turn enables the ADC circuitry 312 to be implemented with less expensive components, thereby reducing cost for the arc detector circuitry 106.

The ADC circuitry 314 has an input coupled to the second output of the LOG AMP circuitry and an output coupled to the RAM 318. Accordingly, the ADC circuitry 314 receives an analog signal that measures the AC energy in the frequency band as described above. The ADC circuitry 314 samples the analog signal and provides at its output digital values that represent the sampled voltages. In this example, the ADC circuitry 314 samples the AC energy signal at a slower rate (for example, 100 kHz as used above) than the frequency band (which spans from 800 kHz to 10 MHz as used above), thereby reducing cost.

In this example, the low-cost hardware used to implement the arc detector circuitry 106 limits the ADC circuitry 314 to a certain number of samples (N) per unit of time. While machine learning algorithms can improve the accuracy of arc detection over known analog threshold techniques, known machine learning algorithms require a number of samples (S_{KNOWN}) per unit of time that is significantly higher than the sample rate of the ADC circuitry 314. Thus, S_{KNOWN}>>N and known machine learning arc detection algorithms are not cost competitive as described above. Advantageously, the LOG AMP circuitry 304 effectively compresses the high frequency data to decrease the value of S₃₂₆ (the required sample rate to run a ML algorithm on the NNPU 326 using the signals from both the ADC circuitry 312 and 314 as inputs) compared to S_{KNOWN}. Because the NNPU 326 is a more efficient processor than other processors that can execute machine learning algorithms (e.g., the CPU 322), the NNPU 326 further lowers the value of S₃₂₆ compared to S_{KNOWN}. Thus, the arc detector circuitry 106 described herein is both accurate and market competitive because S₃₀₆<<N.

The GPIO circuitry 316 and 328 includes pins on the control circuitry 306 that are controlled by the digital domain circuitry 106B and do not have a predefined purpose when the control circuitry 306 is manufactured. Thus, a given instance of the GPIO circuitry is a terminal that may operate as an input, an output, or both based on the particular use case. In this example, the GPIO circuitry 316 is used as an input that receives the frequency detect signal from the LOG AMP circuitry 304 and provides the signal to the ISR 320.

Within the digital domain circuitry 106B, the RAM 318 is an amount of volatile memory 318 that stores data used by programmable circuitry to perform operations. For example, the RAM 318 has inputs coupled to the ADC circuitry 312, the ADC circuitry 314, the ISR 320, the CPU 322, and the 326. The RAM 318 may therefore receive data from any of the foregoing data sources. The RAM 318 also has outputs coupled to the CPU 322 and the NNPU 326 so that both processor units can access the temporary memory.

The ISR 320 has inputs coupled to the CPU 322 and the GPIO circuitry 316 and outputs coupled to the RAM 318, the NNPU 326, and the GPIO circuitry 328. The ISR 320 refers to an amount of volatile memory (called registers) that are separate from the RAM 318. The registers in the ISR 320 generally have a smaller storage capacity than the RAM 318 because the ISR 320 only requires enough data to store interrupts. In this example, the ISR 320 stores a first interrupt that indicates when the frequency detect signal from the GPIO circuitry 316 has a nonzero value. The ISR 320 also stores a second interrupt that indicates when the NNPU 326 detects an arc. In some examples, the ISR 320 also stores other interrupts that indicates other events or statuses throughout the control circuitry 306.

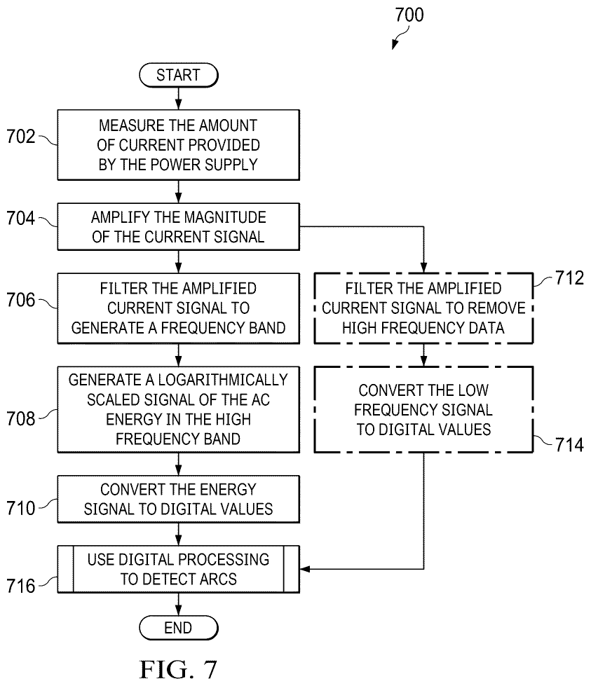

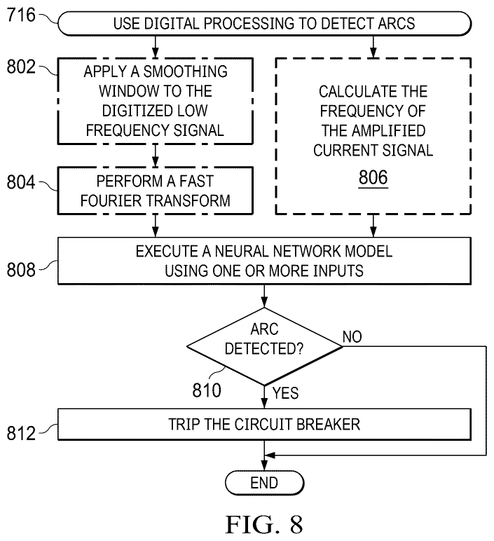

The CPU 322 is a processor that performs operations by executing machine-readable instructions. The CPU 322 is generally considered a primary processor because it manages the operations of the other components in the digital domain circuitry 106B. In some examples, the CPU 322 is instantiated by programmable circuitry executing CPU instructions or performing operations such as those represented by the flowchart(s) of FIGS. 7 and 8.

The flash memory 324 has a first input coupled to the CPU 322, a first output coupled to the CPU 322, and a second output coupled to the NNPU 326. The flash memory 324 refers to a type of electrically erasable programmable read-only memory (EEPROM). Thus, unlike the RAM 318 and ISR 320, data stored in the flash memory 324 is preserved when the control circuitry 306 powers OFF and can be reobtained when the control circuitry 306 subsequently powers back ON.

The NNPU 326 refers to a type of programmable circuitry that is specifically designed to train or execute neural network models. Accordingly, the NNPU 326 may include a different number and a configuration of internal components (for example, arithmetic logic units, floating point units, etc.) such that the NNPU 326 can execute instructions that correspond to a neural network with less time or less power consumption than if the CPU 322 were to execute the same instructions. In this example, the NNPU 326 executes a neural network model that determines in substantially real time whether the AC signal from the AC power supply circuitry 104 is arcing.

The NNPU 326 executes a machine learning model using samples from at least the ADC circuitry 314 (that is, using the energy signal) as an input. In some examples such as FIG. 2, the NNPU 326 also executes the model using data from the amplified current signal and the frequency detect signal as inputs. When available, the amplified current signal and the frequency detect signal provide additional data that may increase the accuracy of the arc detection performed by the NNPU 326. However, in other examples where the LOG AMP circuitry 304 is implemented by a design that provides the energy signal but does not provide the amplified current signal or the frequency detect signal, the NNPU 326 can still detect arcs in a safe and cost-effective manner. In some examples, the NNPU 326 is instantiated by programmable circuitry executing NNPU instructions or performing operations such as those represented by the flowchart(s) of FIGS. 7 and 8.

In this example, the GPIO circuitry 328 is an output of the control circuitry 306 that is coupled to the ISR 320 and the circuit breaker circuitry 108. When the NNPU 326 determines the AC signal is in normal mode, the value of the corresponding interrupt causes the GPIO circuitry 328 to transmit a signal that enables the circuit breaker circuitry 108 to provide the AC signal to the load 110. Alternatively, when the NNPU 326 determines the AC signal is arcing, the NNPU 326 changes (via the RAM 318 and the CPU 322) the value of the corresponding interrupt in the ISR 320. In turn, the GPIO circuitry 328 transmits a signal that trips the circuit breaker circuitry 108 and stops the flow of current to the load 110.

FIG. 4 is a block diagram of an example implementation of the LOG AMP circuitry 304 of FIG. 3. FIG. 4 shows the LOG AMP circuitry 304 includes an example bias resistor (R_{BIAS}) 402, example Low Noise Amplifier (LNA) circuitry 404, example log detector circuitry 406, example buffer circuitry 408, and example inverting buffer circuitry 410.

R_{BIAS} 402 has a first terminal that receives a constant DC voltage (labelled V_{BIAS} in FIG. 2) and a second terminal coupled to an input of the LNA circuitry 404. The foregoing input of the LNA circuitry 404 also receives an alternating voltage signal from the current measurement circuitry 302. R_{BIAS} 402 therefore adds the constant DC voltage to the alternating voltage signal so that the voltage of the sum is within operating range of the LNA circuitry 404.

The LNA circuitry 404 amplifies the magnitude of the signal received at its input while limiting the amount of noise that is added to the signal. The output of the LNA circuitry 404 is coupled to both the BPF circuitry 308 and the LPF circuitry 310. Thus, the signal at the output of the LNA circuitry 404 is the amplified current signal, as labeled in FIG. 3.

The log detector circuitry 406 has an input coupled to the BPF circuitry 308, a first output coupled to both the buffer circuitry 408 and inverting buffer circuitry 410, and a second output coupled to the LPF circuitry 310. The log detector circuitry 406 provides at its first output an envelope signal that is proportional to the frequency band provided at its input. To do so, the log detector circuitry is implemented with n amplifiers in series and adder circuitry that provides the sum from each output of the respective amplifiers.

The log detector circuitry 406 provides at its second output a binary signal that alternates values at the same frequency as the signal provided at its input. To do so, the log detector circuitry 406 includes comparator circuitry that compares the output of the nth amplifier to a reference voltage. The signal at the second output of the log detector circuitry 406 is the frequency detect signal as described in the example of FIG. 3. The performance of the log detector circuitry 406 is described further in connection with FIG. 5.

The buffer circuitry 408 has a first input coupled to the first output of the log detector circuitry 406 and an output coupled to the ADC circuitry 314. The buffer circuitry 408 retransmits at its output the same signal that it receives at its input, thereby lowering the impedance level and reducing the likelihood of signal loss. Similarly, in some examples, the inverted buffer circuitry 410 retransmits at its output a complementary version of the signal that it receives at its input.

FIG. 5 is a graph of an example performance of the log detector circuitry 406 within the LOG AMP circuitry 304 of FIG. 3. The graph of FIG. 5 includes example signals 502 and 504.

The signal 502 is an example of how the voltage received at the input of the log detector circuitry 406 from the BPF circuitry 308 changes over time. Thus, the signal 502 represents the voltage of the amplified current signal when said voltage is alternating within the frequency band. In the example of FIG. 5, the signal 502 shows that the amplified current signal is within the frequency band for approximately 50 microseconds (μs).

The signal 504 is an example of how the voltage provided at the output of the log detector circuitry 406 (to the buffer circuitry 408) changes over time. Furthermore, because the buffer circuitry 408 retransmits the signal it receives at its input without significant changes, the signal 504 can also be referred to as an example implementation of the energy signal as labeled in FIG. 3. The signal 504 shows that the output of the log detector circuitry 406 starts at 0 V and asymptotically approaches a high supply voltage (for example, 50 millivolts (mV) in FIG. 5) while the amplified current signal is within the frequency band. The signal 504 also asymptotically begins to settle back to 0 V once the amplified current signal exits the frequency band.

A naïve approach to arc detection relies primarily on analog processing. For instance, suppose a known commercial arc detector includes a circuit that produces the signal 504 and has a comparator circuit with a threshold voltage of 48 mV. In such a setup, the signal 504 crossing 48 mV a certain number of times within a measurement window can theoretically indicate the AC signal is arcing. However, the foregoing variables are difficult to tune in practice because many types of devices that may implement the load 110 (including but not limited to switches, brushed motors, etc.) have similar current patterns that can lead to false tripping. Advantageously, the arc detector circuitry 106 described herein digitizes the signal 504 and provides said data to the NNPU 326 for further analysis. The NNPU 326 executes a machine learning algorithm that defines an arc threshold based on a comparatively large number (e.g., on the scale of hundreds or more) of derived arc features and neurons. In contrast, the naïve approach uses a comparatively small number of comparisons (e.g., on the scale of tens or less) that limits accuracy.

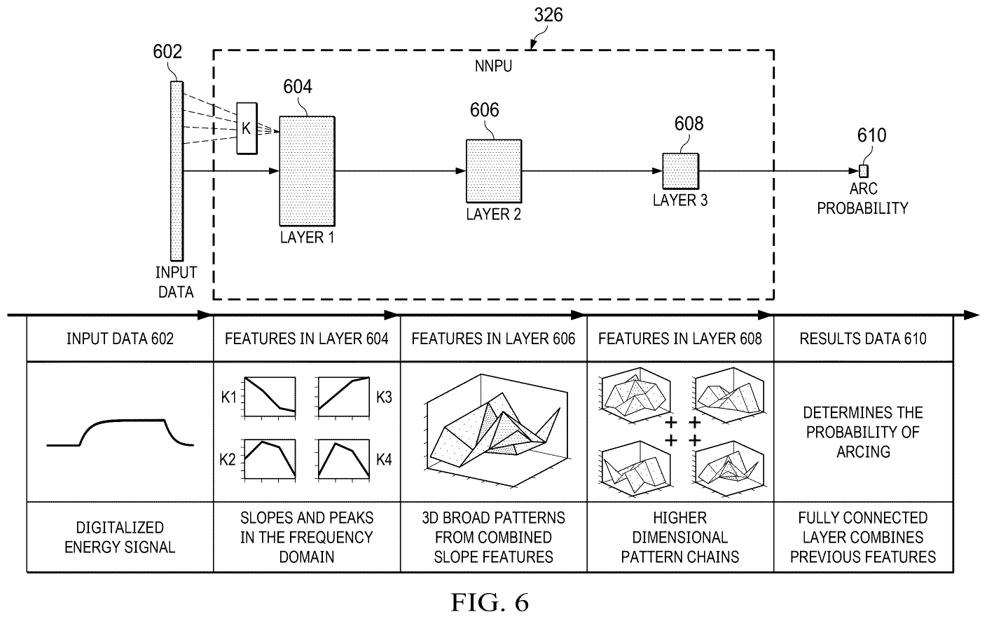

FIG. 6 is an illustrative example of operations performed by the neural network processor unit (NNPU) of FIG. 3. In the example of FIG. 6, the NNPU 326 implements example layers 604, 606, and 608. FIG. 6 also includes example input data 602 and example results data 610.

The input data 602 represents data provided at the inputs of the NNPU 326. Thus, the input data 602 includes at least digital samples of the energy signal. The input data 602 may also include data that represents analysis performed by the CPU 322 using a) the amplified current signal and b) the frequency detect signal. The optional analysis of the foregoing signals by the CPU 322 is described further in connection with FIG. 8. In general, the input data 602 represents a greater amount of data than the data passed through any of the layers 604-608.

The layer 604 produces, based on the input data 602, new features that represent slopes and peaks of the energy signal in the frequency domain. The layer 604 may be implemented by any number and any configuration of nodes.

The layer 606 produces, based on the features from the layer 604, new features that represent broad patterns identified from a combination of one or more of the slopes or peaks in the frequency domain. In this example, a given pattern identified by the layer 606 is represented in three dimensions as shown by the corresponding graph in FIG. 6. In other examples, the layer 606 uses a different number of dimensions to characterize a given pattern. In this example, the layer 606 is implemented with a smaller number of nodes than the layer 604. More generally, the layer 606 may be implemented by any number and any configuration of nodes.

The layer 608 produces the result data 610 based on the features from the layer 606. In this example, the result data includes a probability that the AC signal contains an arc and may include additional information. To generate the result data 610, the layer 608 combines the broad patterns from the layer 606 into chains of higher dimensional patterns and interprets the high dimensional patterns. In this example, the layer 608 is implemented with a smaller number of nodes than the layer 606. In other examples, the layer 608 is implemented by a different number and different configuration of nodes.

FIG. 6 shows one example implementation of a three-dimensional convolutional neural network model implemented by the NNPU 326. More generally, the digital domain circuitry 106B may implement any type of artificial intelligence model or machine learning model (including but not limited to neural networks) that receives at least the digitalized energy signal at its inputs and produces at a probability of arcing its output. Accordingly, in other examples, the NNPU 326 may implement a neural network model that has a different number of layers, a different feature space configuration, a different architecture (for example, a Recurrent Neural Network (RNN), a Generative Adversarial Network (GNN), a Radial Basis Function (RBF) network, a Deep Neural Network (DNN), etc.), or other characteristics that are different than the model shown in the example of FIG. 6.

Known arc detection techniques that use machine learning models to detect arcs generally do so by a) representing the AC signal as digital data organized into various frequency bins and b) analyzing how the data in the frequency bins changes over a set period. Such techniques require programmable circuitry to organize the digital data into the frequency bins by performing a Fast Fourier Transform (FFT) on the time series data that is measured from the AC signal. However, FFT requires computationally expensive operations that increase the cost of implementing such an arc detection technique. Furthermore, known arc detection techniques that use digital analysis generally produce a large amount of time series data because the ADC circuitry used in such techniques sample high frequency bands (for example, on the MHz scale) above their Nyquist frequencies to avoid aliasing. This large amount of data corresponds require a large number of FFT operations, further adding to the cost of such an implementation.

Rather than performing a FFT on a digitalized version of a high frequency band, the log detector circuitry 406 described herein preconditions the analog version of high frequency band. The envelope signal produced by the log detector circuitry 406 is similar in nature to the data produced by FFT operations because both results describe how the instantaneous frequency of the AC signal changes over time. Thus, in this example, the CPU 322 does not perform any signal processing on the data provided by the ADC circuitry 314 before it is received as the primary input to the NNPU 326. Accordingly, the arc detector circuitry 106 described herein can detect arcs as accurately as the known arc detection techniques that use machine learning models but does so at a lower cost than said techniques, by performing analog log detection operations instead of digital FFT operations on the primary input to the NNPU 326.

FIG. 7 is a flowchart representative of example machine readable instructions or example operations 700 that may be executed, instantiated, or performed to implement the arc detector circuitry 106. The example machine-readable instructions or the example operations 700 of FIG. 7 begin when the current measurement circuitry 302 measures the amount of current provided by the power supply (for example, the amount of current in the AC signal labeled in FIG. 1). (Block 702). The current measurement circuitry 302 may be implemented using any suitable arc detection technique as described above. In this example, the current measurement circuitry 302 repeatedly implements block 702 by taking periodic measurements of the current whenever the AC power supply circuitry 104 is powered ON. Accordingly, the analog voltage produced at the output of the current measurement circuitry 302 changes over time. In this example, the foregoing changes in voltage are referred to as the current signal.

The LNA circuitry 404 amplifies the magnitude of the current signal. (Block 704). The amplification increases the scale of features within the current signal so they are easier to detect by other components downstream. The BPF circuitry 308 then filters the amplified current signal to generate a frequency band. (Block 706). In the examples described herein, the signal at the output of the BPF circuitry 308 may be referred to as a high frequency band because the signal ranges from 800 kHz to 10 MHz. In other examples, the BPF circuitry 308 produces a different frequency band of the amplified current signal at block 706.

The log detector circuitry 406 generates a logarithmically scaled signal of the AC energy in the frequency band. (Block 708). As described in FIG. 5, the signal produced at block 708 indicates how long the AC signal has remained continuously within the frequency band. The buffer circuitry 408 also retransmits the signal produced from the log detector circuitry 406 at block 708. Accordingly, the signal generated at block 708 is an example implementation of the energy signal labeled in FIG. 3.

The ADC circuitry 314 converts the energy signal to a series of digital values. (Block 710). In this example, the ADC circuitry 314 samples the energy signal below the Nyquist rate of the frequency band produced at block 706. The ADC circuitry 314 implements this comparatively slow sample rate (and therefore implements a comparatively low data resolution) because the energy signal changes at a slower rate than the corresponding frequency band (for example, in FIG. 5, compare the rate of change in the signal 504 to the rate of change in the signal 502).

After implementing block 704 and in parallel with blocks 706-710, the LPF circuitry 310 optionally filters a copy of the amplified current signal to remove high frequency data. (Block 712). In such examples, the ADC circuitry 312 then converts the resulting low frequency data into digital values. (Block 714).

After block 710, and optionally after block 714, the digital domain circuitry 106B uses digital processing to protect the load 110 from arcs. (Block 716). Implementation of block 716 is described further in connection with FIG. 8. The machine-readable instructions or operations 700 end after block 716.

FIG. 8 is a flowchart representative of example operations that may be executed, instantiated, or performed by the digital domain circuitry of FIG. 3 to detect arcs. FIG. 8 is an example implementation of block 716 of FIG. 7.

In examples where the LOG AMP circuitry 304 provides the amplified current signal to the control circuitry 306 (for example, where blocks 712 and 714 of FIG. 7 are implemented), execution of block 716 begins when the CPU 322 applies a smoothing window to the digitized low frequency signal. (Block 802). The smoothing window helps maintain signal continuity and reduce spectral leakage. In the example of FIG. 8, the CPU 322 implements block 802 by implementing a Hanning window to n consecutive digital values produced at block 714, where n is any natural number. In other examples, the CPU 322 implements block 802 using a different type of signal processing operations. In still other examples, the LOG AMP circuitry 304 does not generate the amplified current signal and blocks 712, 714, 802, 804 are not implemented.

In examples where block 802 is implemented, the CPU 322 performs a FFT on the data generated by the application of the smoothing window. (Block 804). The FFT operations convert the digital data from the time domain to the frequency domain. Notably, the CPU 322 implements block 804 with a comparatively small amount of data because the amplified current signal is passed through the LPF circuitry 310. In contrast, known arc detection techniques that use machine learning generally sample a comparatively high frequency band and therefore perform FFT operations on significantly more data. Accordingly, FFT operations at block 804 are less computationally expensive than FFT operations performed by known arc detector systems.

In some examples, the LOG AMP circuitry 304 generates the frequency detect signal described above. In such examples, after implementing block 708 and in parallel with one or more of blocks 710-804, the CPU 322 calculates the frequency of the amplified current signal. (Block 806). To do so, the CPU 322 runs an Interrupt Service Routine based on the status flag within the Interrupt Status Register 320 that changes state based on the frequency detect signal. The Interrupt Service Routine enables the CPU 322 to recover information that is removed during the enveloping operations of the log detector circuitry 406 (for example, to create a digitalized version of the signal 502 of FIG. 5).

The NNPU 326 executes a neural network model using one or more inputs. (Block 808). The one or more inputs include at least the digital samples of the energy signal (for example, the output of block 710). In some examples, the inputs to the NNPU 326 also include one or both of a) the result of the FFT from block 804 and b) the frequency data of the amplified current signal recovered at block 806. The NNPU 326 may implement any type and any size of neural network model that at block 808. The result of the neural network model execution at block 808 includes a probability that the AC signal is arcing.

The CPU 322 determines whether an arc has been detected. (Block 810). To do so, the CPU 322 compares the arc probability generated by the NNPU 326 to a threshold value (for example, 50%). In this example, the CPU 322 determines an arc has been detected if the arc probability is greater or equal to the threshold value and determines an arc has not been detected if the arc probability is less than the threshold value. The CPU 322 may implement block 810 by applying any suitable threshold value.

In this example, the neural network model of block 808 updates, and a new arc probability value is produced, once every 8.33 ms as described above. However, industry standards define an arc as having a minimum period of 100 ms. Therefore, in this example, the CPU 322 determines an arc has been detected (Block 810: Yes) once twelve consecutive updates of the arc probability are above the threshold value (as 100/8.33≈12). More generally, the NNPU 326 may run at any processing speed, and the CPU 322 may use any number of consecutive arc probability updates to define an arc at block 810.

If the CPU 322 determines an arc is detected (Block 810: Yes), the CPU 322 trips the circuit breaker circuitry 108. (Block 812). In this example, the CPU 322 implements block 812 by sending a signal, via the ISR 320 and the GPIO circuitry 328, that causes the circuit breaker circuitry 108 to stop the flow of the current (for example, the AC signal) to the load 110. The machine-readable instructions or operations 700 end after block 812 or if the CPU 322 determines an arc has not been detected (Block 810: No).

In this example, the arc detector circuitry 106 performs substantially real time arc detection by executing one or more blocks in the flowchart of FIGS. 7 and 8 continuously and in parallel with one another. For example, the current measurement circuitry 302 creates the current signal by continuously executing block 702 as described above. Similarly, by continuously executing block 710, the ADC circuitry 314 creates a stream of digital values that reflects changes in the current signal as said changes occur. At block 808, the NNPU 326 repeatedly re-executes the neural network model using different sections of the stream of digital values at each iteration. In some examples, the NNPU 326 implements a pipeline architecture so that multiple iterations of the neural network model can execute concurrently with one another at different stages. For example, in a pipeline architecture, the NNPU 326 may implement the operations for layer 606 based on first data from block 710 and implement the operations for layer 604 based on second data from block 710 at the same time. Notably, the design of the arc detector circuitry 106 described above (for example, performing analog preconditioning with the log detector circuitry 406 rather than performing digital FFT operations, sampling the energy signal and optionally the amplified current signal at low frequencies to reduce the number of digital values per unit of time, etc.) enables the digital domain circuitry 106B to execute block 716 quickly enough to support substantially real time arc detection while also detecting arcs more accurately than known commercial alternatives. Thus, the arc detector circuitry 106 is a cost-effective architecture that mitigates the likelihood of an arc causing damage and reduces the likelihood of false positives, thereby reducing system down time and improving user experience.

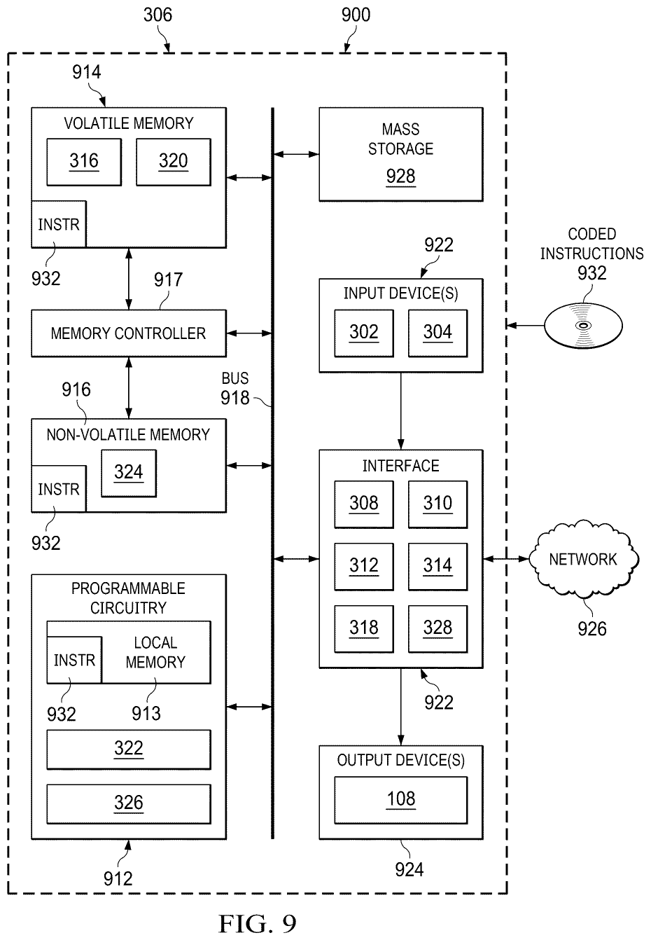

FIG. 9 is a block diagram of an example programmable circuitry platform 900 structured to execute or instantiate the example machine-readable instructions or the example operations of FIGS. 7 and 8 to implement the control circuitry 306 of FIG. 3. The programmable circuitry platform 900 can be, for example, any type of computing or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, or microcontrollers from any desired family or manufacturer. The programmable circuitry 912 may be implemented by one or more semiconductor based (for example, silicon based) devices. In this example, the programmable circuitry 912 implements the CPU 322 and the NNPU 326.

The programmable circuitry 912 of the illustrated example includes a local memory 913 (for example, a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), or any other type of RAM device. The non-volatile memory 916 may be implemented by flash memory or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916. In this example, the volatile memory 914 implements the RAM 318 and the ISR 320 while the non-volatile memory 916 implements the flash memory 324.

The programmable circuitry platform 900 of the illustrated example also includes interface circuitry 920. The interface circuitry 920 may be implemented by hardware that complies with any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface. In this example, the interface circuitry 920 implements the BPF circuitry 308, the LPF circuitry 310, the ADC circuitry 312 and 314, and the GPIO circuitry 316 and 328.

In the illustrated example, one or more input devices 922 are connected to the interface circuitry 920. The input device(s) 922 permit(s) a user (for example, a human user, a machine user, etc.) to enter data or commands into the programmable circuitry 912. In this example, the input device(s) 922 are implemented by the current measurement circuitry 302 and the LOG AMP circuitry 304.

One or more output devices 924 are also connected to the interface circuitry 920 of the illustrated example. The output device(s) 924 can be implemented, for example, by display devices (for example, a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 920 of the illustrated example, thus, generally includes a graphics driver card, a graphics driver chip, or graphics processor circuitry such as a GPU. In this example, the output device(s) 924 are implemented by the circuit breaker circuitry 108.

The interface circuitry 920 of the illustrated example also includes a communication device such as a transmitter, a receiver, a transceiver, a modem, a residential gateway, a wireless access point, or a network interface to facilitate exchange of data with external machines (for example, computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, or data. Examples of such mass storage discs or devices 928 include magnetic storage devices (for example, floppy disk, drives, HDDs, etc.), optical storage devices (for example, Blu-ray disks, CDs, DVDs, etc.), RAID systems, or solid-state storage discs or devices such as flash memory devices or SSDs.

The machine readable instructions 932, which may be implemented by the machine readable instructions of FIGS. 7 and 8, may be stored in the mass storage device 928, in the volatile memory 914, in the non-volatile memory 916, or on at least one non-transitory computer readable storage medium such as a CD or DVD which may be removable.

While an example manner of implementing the arc detector circuitry 106 of FIG. 1 is illustrated in FIG. 3, one or more of the elements, processes, or devices illustrated in FIG. 3 may be combined, divided, re-arranged, omitted, eliminated, or implemented in any other way. Further, the LPF circuitry 310, the ADC circuitry 312 and 314, the GPIO circuitry 316 and 328, the ISR 320, the CPU 322, the NNPU 326, or, more generally, the example arc detector circuitry 106 of FIG. 3, may be implemented by hardware alone or by hardware in combination with software or firmware. Thus, for example, any of the LPF circuitry 310, the ADC circuitry 312 and 314, the GPIO circuitry 316 and 328, the ISR 320, the CPU 322, the NNPU 326, or, more generally, the example arc detector circuitry 106, could be implemented by programmable circuitry in combination with machine readable instructions (for example, firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example arc detector circuitry 106 of FIG. 3 may include one or more elements, processes, or devices in addition to, or instead of, those illustrated in FIG. 3 or may include more than one of any or all of the illustrated elements, processes and devices.

Flowchart(s) representative of example machine readable instructions, which may be executed by programmable circuitry to implement or instantiate the arc detector circuitry 106 of FIG. 3 or representative of example operations which may be performed by programmable circuitry to implement or instantiate the arc detector circuitry 106 of FIG. 3, are shown in FIGS. 7 and 8. In some examples, the machine readable instructions cause an operation, a task, etc., to be carried out or performed in an automated manner in the real world. As used herein, “automated” means without human involvement.

The program may be embodied in instructions (for example, software or firmware) stored on one or more non-transitory computer readable or machine readable storage medium such as cache memory, a magnetic-storage device or disk (for example, a floppy disk, a Hard Disk Drive (HDD), etc.), an optical-storage device or disk (for example, a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (for example, electrically erasable programmable read-only memory (EEPROM), flash memory, etc.), volatile memory (for example, Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (for example, a server and a client hardware device). For example, the client hardware device may be implemented by an endpoint client hardware device (for example, a hardware device associated with a human or machine user) or an intermediate client hardware device gateway (for example, a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7 and 8, many other methods of implementing the example arc detector circuitry 106 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (for example, processor circuitry, discrete or integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (for example, a single-core processor (for example, a single core CPU), a multi-core processor (for example, a multi-core CPU, an XPU, etc.)). For example, the programmable circuitry may be a CPU or an FPGA located in the same package (for example, the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (for example, computer-readable data, machine-readable data, one or more bits (for example, one or more computer-readable bits, one or more machine-readable bits, etc.), a bitstream (for example, a computer-readable bitstream, a machine-readable bitstream, etc.), etc.) or a data structure (for example, as portion(s) of instructions, code, representations of code, etc.) that may be utilized to create, manufacture, or produce machine executable instructions. For example, the machine-readable instructions may be fragmented and stored on one or more storage devices, disks or computing devices (for example, servers) located at the same or different locations of a network or collection of networks (for example, in the cloud, in edge devices, etc.). The machine-readable instructions may require one or more of installation, modification, adaptation, updating, combining, supplementing, configuring, decryption, decompression, unpacking, distribution, reassignment, compilation, etc., to be directly readable, interpretable, or executable by a computing device or other machine. For example, the machine readable instructions may be stored in multiple parts, which are individually compressed, encrypted, or stored on separate computing devices, the parts when decrypted, decompressed, or combined form a set of computer-executable or machine executable instructions that implement one or more functions or operations that may together form a program such as that described herein.

In another example, the machine readable instructions may be stored in a state in which they may be read by programmable circuitry, but require addition of a library (for example, a dynamic link library (DLL)), a software development kit (SDK), an application programming interface (API), etc., in order to execute the machine-readable instructions on a particular computing device or other device. In another example, the machine-readable instructions may need to be configured (for example, settings stored, data input, network addresses recorded, etc.) before the machine readable instructions or the corresponding program(s) can be executed in whole or in part. Thus, machine readable, computer readable or machine-readable media, as used herein, may include instructions or program(s) regardless of the particular format or state of the machine readable instructions or program(s).

The machine-readable instructions described herein can be represented by any past, present, or future instruction language, scripting language, programming language, etc. For example, the machine-readable instructions may be represented using any of the following languages: C, C++, Java, C-sharp, Perl, Python, JavaScript, HyperText Markup Language (HTML), Structured Query Language (SQL), Swift, etc.

As mentioned above, the example operations of FIGS. 7 and 8 may be implemented using executable instructions (for example, computer readable or machine-readable instructions) stored on one or more non-transitory computer readable or machine-readable media. As used herein, the terms non-transitory computer readable medium, non-transitory computer readable storage medium, non-transitory machine readable medium, or non-transitory machine readable storage medium are expressly defined to include any type of computer readable storage device or storage disk and to exclude propagating signals and to exclude transmission media. Examples of such non-transitory computer readable medium, non-transitory computer readable storage medium, non-transitory machine readable medium, or non-transitory machine readable storage medium include optical storage devices, magnetic storage devices, an HDD, a flash memory, a read-only memory (ROM), a CD, a DVD, a cache, a RAM of any type, a register, or any other storage device or storage disk in which information is stored for any duration (for example, for extended time periods, permanently, for brief instances, for temporarily buffering, or for caching of the information). As used herein, the terms “non-transitory computer readable storage device” and “non-transitory machine-readable storage device” are defined to include any physical (mechanical, magnetic or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, or redundant array of independent disks (RAID) systems. As used herein, the term “device” refers to physical structure such as mechanical or electrical equipment, hardware, or circuitry that may or may not be configured by computer readable instructions, machine readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (for example, comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended.

As used herein, singular references (for example, “a,” “an,” “first,” “second,” etc.) do not exclude a plurality. The term “a” or “an” object, as used herein, refers to one or more of that objects. The terms “a” (or “an”), “one or more,” and “at least one” are used interchangeably herein. Furthermore, although individually listed, a plurality of means, elements, or actions may be implemented by, for example, the same entity or object. Furthermore, although individual features may be included in different examples or claims, these may possibly be combined, and the inclusion in different examples or claims does not imply that a combination of features is not feasible or advantageous.

In this description, the phrase “at least one of A or B” (or “at least one of A and B”) refers to implementations including any of: (a) at least one A; (b) at least one B; and (c) at least one A and at least one B.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

Numerical identifiers such as “first,” “second,” “third,” etc. are used merely to distinguish between elements of substantially the same type in terms of structure or function. These identifiers as used in the detailed description do not necessarily align with those used in the claims.

A device that is “configured to” perform a task or function may be configured (for example, programmed or hardwired) at a time of manufacturing by a manufacturer to perform the function or may be configurable (or re-configurable) by a user after manufacturing to perform the function or other additional or alternative functions. The configuring may be through firmware or software programming of the device, through a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, or inductors), or one or more sources (such as voltage or current sources) may instead include only the semiconductor elements within a single physical device (for example, a semiconductor die or integrated circuit (IC) package) and may be adapted to be coupled to at least some of the passive elements or the sources to form the described structure either at a time of manufacture or after a time of manufacture, for example, by an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; or (iv) incorporated in/on the same printed circuit board.

Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that reduce the cost and increase the accuracy of arc detection. Described systems, apparatus, articles of manufacture, and methods improve the efficiency of using a computing device by implementing analog domain circuitry and digital domain circuitry. In the analog domain circuitry, example logarithmic (LOG) amplifier circuitry generates a logarithmically scaled signal of the AC energy within a high frequency band of a current signal. The example LOG amplifier circuitry may also provide a low frequency band of the current signal and frequency detect signal. Within the digital domain circuitry, an example artificial intelligence (AI) model uses at least a digitized version of the logarithmically scaled signal to detect arcs in the current signal. The AI model enables the example arc detector circuitry to be more accurate than known commercial arc detectors. The signal preconditioning performed in the analog domain circuitry also enables the digital domain circuitry to perform accurate arc detection accurately while requiring a relatively small number of computational resources and consuming a relatively low amount of power in comparison to other known arc detection techniques. Thus, the example combination of analog preprocessing and digital analysis described herein is more accurate and less expensive than known arc detection techniques. Described systems, apparatus, articles of manufacture, and methods are accordingly directed to one or more improvement(s) in the operation of a machine such as a computer or other electronic or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
current measurement circuitry having an output;
log amplifier circuitry having an input coupled to the output of the current measurement circuitry and having an output;
analog to digital conversion (ADC) circuitry having an input coupled to the output of the log amplifier circuitry and an output; and
programmable circuitry having an input coupled to the output of the ADC circuitry and having an output, wherein the programmable circuitry is configured to detect an arc within an Alternating Current (AC) signal provided to the current measurement circuitry.

2. The apparatus of claim 1, wherein:
the programmable circuitry has an output that is configured to be coupled to a circuit breaker; and
the programmable circuitry is further configured to trip the circuit breaker in response the detection.

3. The apparatus of claim 1, wherein the current measurement circuitry has an input that is configured to be coupled to power supply circuitry, the power supply circuitry configured to provide the AC signal to the current measurement circuitry.

4. The apparatus of claim 3, wherein:
the current measurement circuitry is configured to produce a signal that is proportional to an amount of current in the AC signal; and
the log amplifier circuitry further includes amplifier circuitry configured to amplify a magnitude of the signal generated by the current measurement circuitry.

5. The apparatus of claim 4, wherein the apparatus further includes band pass filter (BPF) circuitry configured to generate a high frequency band of the signal generated by the amplifier circuitry.

6. The apparatus of claim 5, wherein the log amplifier circuitry further includes log detector circuitry configured to produce a logarithmically scaled representation of AC energy within the high frequency band.

7. The apparatus of claim 5, wherein the ADC circuitry is configured to sample a signal provided by the log amplifier circuitry below a Nyquist rate of the high frequency band.

8. The apparatus of claim 1, wherein the programmable circuitry is configured to detect the arc by executing a machine learning model using samples generated by the ADC circuitry.

9. The apparatus of claim 1, wherein the programmable circuitry is implemented by a Neural Network Processor Unit.

10. The apparatus of claim 1, wherein the current measurement circuitry is implemented using a shunt resistor, a Rogowski Coil, or a current transformer.

11. An apparatus comprising:
current measurement circuitry having an output;
log amplifier circuitry having an input coupled to the output of the current measurement circuitry; and
control circuitry having an input coupled to the log amplifier circuitry and having an output coupled to a circuit breaker, wherein the control circuitry is configured to:
detect an arc within an alternating current (AC) signal provided to the current measurement circuitry; and
trip the circuit breaker in response to the detection.

12. The apparatus of claim 11, wherein the input of the log amplifier circuitry is a first input, wherein the apparatus includes:
Band Pass Filter (BPF) circuitry having an input coupled to a first output of the log amplifier circuitry and having an output coupled to a second input of the log amplifier circuitry; and
Low Pass Filter (LPF) circuitry having an input coupled to a second output of the log amplifier circuitry and having an output.

13. The apparatus of claim 12, wherein the BPF circuitry and the LPF circuitry are implemented within the control circuitry.

14. The apparatus of claim 12, wherein the control circuitry includes:
first analog to digital conversion (ADC) circuitry having an input coupled to a third output of the log amplifier circuitry and having an output;
second ADC circuitry having an input coupled to the output of the LPF circuitry and having an output;
first General Purpose Input Output (GPIO) circuitry having an input coupled to a fourth output of the log amplifier circuitry and having an output; and
second GPIO circuitry having an input coupled to the output of the first GPIO circuitry and having an output coupled to the circuit breaker.

15. The apparatus of claim 14, wherein the control circuitry includes:
an Interrupt Status Register (ISR) having an input coupled to the first GPIO circuitry and an output coupled the second GPIO circuitry;
memory coupled to the ISR; and
one or more processors coupled to the both the memory and the ISR.

16. A non-transitory machine readable storage medium comprising instructions that, when executed, cause at least one processor to detect an arc by executing a machine learning model, wherein an input to the machine learning model are digital samples that correspond to a logarithmically scaled representation of energy within a frequency band of an Alternating Current (AC) signal.

17. The non-transitory machine-readable storage medium of claim 16, wherein the machine learning model is a Convolutional Neural Network.

18. The non-transitory machine-readable storage medium of claim 16, wherein the at least one processor is to:
identify, with the machine learning model, high dimensional patterns in the digital samples; and
interpret the high dimensional patterns to generate a probability that the AC signal contains the arc.

19. The non-transitory machine-readable storage medium of claim 16, wherein:
the frequency band is a first frequency band;
the digital samples are first digital samples; and
the instructions, when executed, cause the at least one processor to execute the machine learning model using both the first digital samples and second digital samples, wherein the second digital samples correspond to a second frequency band of the AC signal.

20. The non-transitory machine-readable storage medium of claim 16, wherein:
the digital samples are first digital samples; and
the instructions, when executed, cause the at least one processor to detect the arc by execute the machine learning model using both the first digital samples and second digital samples, wherein the second digital samples describe an instantaneous frequency of the AC signal.
